(19) United States
(12) Patent Application Publication
(10) Pub. No.: US 2018/0241080 A1
(43) Pub. Date: Aug. 23, 2018

(54) CLUSTER-ION BASED SUPERIONIC CONDUCTORS

(71) Applicant: Virginia Commonwealth University, Richmond, VA (US)

(72) Inventors: Purusottam Jena, Richmond, VA (US); Hong Fang, Richmond, VA (US)

(21) Appl. No.: 15/901,180

(22) Filed: Feb. 21, 2018

Related U.S. Application Data
(60) Provisional application No. 62/461,421, filed on Feb. 21, 2017.

(51) Int. Cl. H01M 10/0562; H01M 10/0525; C01B 35/14; H01M 10/054

(52) U.S. Cl. CPC H01M 10/0562; H01M 10/0525; C01B 35/14; C01P 2002/30; H01M 2300/008; C01P 2006/40; H01M 10/054

(57) ABSTRACT

Cluster-ion based superionic conductors are provided as are solid electrolytes comprising cluster-ion based superionic conductors. The solid electrolytes are use, for example, in solid state batteries.

### CROSS-REFERENCE TO RELATED APPLICATIONS

This application claims benefit of U.S. provisional patent application 62/461,421, filed Feb. 21, 2017, the complete contents of which is hereby incorporated by reference.

### STATEMENT OF FEDERALLY SPONSORED RESEARCH AND DEVELOPMENT

This invention was made with government support under Grant Number: DE-FG02-96ER45579 awarded by the Department of Energy. The United States government has certain rights in the invention.

### BACKGROUND OF THE INVENTION

### Field of the Invention

The invention generally relates to cluster-ion based superionic conductors. In particular, the invention provides solid electrolytes comprising cluster-ion based superionic conductors for use in e.g. solid state batteries.

### Description of Background Art

From cell phones to artificial hearts and from electric vehicles to satellites, batteries have become an indispensable technology in modern society. Compared to batteries with liquid electrolytes, batteries with solid electrolytes hold the promise of greater safety, higher power and higher energy densities. However, development of all-solid-state batteries is limited by the relatively low conductivity of solid electrolyte materials.

Most types of superionic conductors have an activation energy in the range of 0.3-0.6 eV and exhibit ionic conductivities of the order of 10⁻⁴-10⁻³ S/cm at room temperature (RT). On the other hand, a typical organic liquid electrolyte or a gel electrolyte in practical batteries has a RT conductivity around 10⁻² S/cm. Unfortunately, attaining a Li⁺ conductivity over 10⁻³ S/cm in the solid state is particularly challenging. Very few lithium solid electrolytes can reach a RT conductivity at or near 10⁻² S/cm. Those which can include Li₇P₃S₁₁ (1.7×10⁻² S/cm) with an activation energy of 0.18 eV and the LGPS materials, i.e. Li_{3.25}Ge_{0.25}P_{0.75}S₄ (2.2×10⁻³ S/cm) and Li₁₀GeP₂S₁₂ (1.2×10⁻² S/cm) with activation energies of 0.22-0.25 eV. However, Li₇P₃S₁₁ has issues of chemical stability, while the LGPS materials only show a one-dimensional (1D) conduction pathway (along the C axis) and contain expensive Germanium, which makes these materials less useful for practical applications. In 2016, a chlorine-doped system, Li_{9.54}Si_{1.74}P_{1.44}S_{11.7}Cl_{0.3}, with the LGPS crystal structure was discovered, which has an activation energy similar to that of LGPS and sets the record of RT Li⁺ conductivity to 2.5×10⁻² S/cm.

It is highly desirable to develop improved superionic conductors that exhibit improved (greater) three-dimensional RT Li⁺ conductivities and improved (lower) activation energies than those which are known in the prior art.

### SUMMARY OF THE INVENTION

Other features and advantages of the present invention will be set forth in the description of invention that follows, and in part will be apparent from the description or may be learned by practice of the invention. The invention will be realized and attained by the compositions and methods particularly pointed out in the written description and claims hereof.

The present disclosure provides improved superionic conductors that exhibit improved three-dimensional RT Li⁺ conductivities and activation energies compared to prior ionic conductors. The superionic conductors, which exhibit three-dimensional RT Li⁺ conductivities greater than 10⁻³ S/cm and activation energies smaller than 0.25 eV, are a new family of lithium-rich antiperovskites which comprise, in an exemplary aspect, cluster ions Li₃O⁺/Li₃S⁺ and BH₄⁻/AlH₄⁻/BF₄⁻. These new superionic conductors are called “super” lithium-rich antiperovskites” (super-LRAPs) because the cluster cations, which have ionization potentials smaller than that of alkali elements, are called super-alkalis while the cluster anions, which have vertical detachment energies larger than that of halogen elements, are called super-halogens. As shown herein, a lithium superionic conductor Li₃SBF₄ with an antiperovskite crystal structure has an estimated RT conductivity of 10⁻² S/cm and an activation energy of 0.210 eV. The material also exhibits a very large band gap (around 8.5 eV), a high melting point (over 600 K), a small formation energy (less than 40 meV/atom) and favorable mechanical properties. In addition, by partially replacing the super-halogen ion BF₄⁻ with chlorine, a mixed phase superionic conducting material, Li₃S(BF₄)_{0.5}Cl_{0.5}, was developed which showed a conductivity over 10⁻¹ S/cm at RT and an activation energy as low as 0.176 eV. The superionic conductors advantageously have room temperature conductivities that are comparable to those of liquid organic electrolytes. The invention also provides ways to design and realize cluster-ions based superionic conductors (solid electrolytes) with antiperovskite structures, particularly, Li₃S(BF₄) and Li₃S(BF₄)_{0.5}Cl_{0.5}. The cluster ions include, for example, Li₃O⁺, Li₃S⁺, Na₃O⁺, Na₃S⁺, AlH₄⁻, BH₄⁻, BF₄⁻ and BCl₄⁻.

It is an object of this invention to provide a solid superionic conductor material comprising i) Li or Na super-alkali cluster cations; ii) super-halogen cluster anions; and, optionally, iii) halogen anions, wherein the superionic conductor material has an antiperovskite crystal structure. In some aspects, the Li or Na super-alkali cluster cations are selected from the group consisting of: Li₃O⁺, Li₃S⁺, Na₃O⁺ and Na₃S⁺. In some aspects, the super-halogen cluster anions are selected from the group consisting of: BH₄⁻, AlH₄⁻, BF₄⁻ and BCl₄⁻. In additional aspects, the halogen anions is selected from the group consisting of: Cl⁻, Br⁻ and I⁻. In further aspects, the ionization potentials of the Li or Na super-alkali cluster cations are smaller than those of alkali elements, and in yet further aspects, the vertical detachment energies of the super-halogen cluster anions are larger than those of halogen elements. In some aspects, the solid superionic conductor material comprises Li₃SBF₄. In other aspects, the solid superionic conductor material comprises Li₃S(BF₄)₁₋ₓClₓ, where 0<x<1. In further aspects, a band gap of the solid superionic conductor material is at least about 4.0 eV. In additional aspects, the band gap is about 8.5 eV. In additional aspects, an activation energy of the solid superionic conductor material is 0.25 eV or less. In yet further aspects, the activation energy is about 0.210 eV; and in even further aspects, the activation energy is about 0.176 eV. In some aspects, the RT Li⁺ ionic conductivity of the solid superionic conductor material is 10⁻³ S/cm or greater at room temperature (RT). In other aspects, the three-dimensional RT Li⁺ ionic conductivity is above 10⁻² S/cm, and in additional aspects, the three-dimensional RT Li⁺ ionic conductivity is above 10⁻¹ S/cm. In aspects of the invention, a melting point of the solid superionic conductor material is 400 K or greater.

The invention also provides a rechargeable solid-state battery comprising i) an anode ii) a cathode; and ii) a solid superionic conductor material comprising: Li or Na super-alkali cluster cations; super-halogen cluster anions; and, optionally, halogen anions, wherein the superionic conductor material has an antiperovskite crystal structure. In some aspects, the solid superionic conductor material is Li₃SBF₄ or Li₃S(BF₄)₁₋ₓClₓ where 0<x<1. In other aspects, the solid superionic conductor material is Na₃SBCl₄ or Na₃S(BCl₄)₁₋ₓIₓ where 0<x<1.

The invention also provides a rechargeable device or vehicle comprising a rechargeable solid-state battery comprising i) an anode ii) a cathode; and ii) a solid superionic conductor material comprising: Li or Na super-alkali cluster cations; super-halogen cluster anions; and, optionally, halogen anions, wherein the superionic conductor material has an antiperovskite crystal structure. In some aspects, the solid superionic conductor material is Li₃SBF₄ or Li₃S(BF₄)₁₋ₓClₓ where 0<x<1. In other aspects, the solid superionic conductor material is Na₃SBCl₄ or Na₃S(BCl₄)₁₋ₓIₓ where 0<x<1.

### BRIEF DESCRIPTION OF THE DRAWINGS

FIG. 1. Planar configuration of Li₃O⁺ and Li₃S⁺ super-alkalies in the gas phase.

FIG. 2. Molecular dynamics simulation at 300 K of the super-alkalies inside a perovskite framework of AGeI₃ (A=the super-alkali). The planar configuration of the super-alkali assumes a pyramidal configuration due to the interaction between the neighbors.

FIG. 3A-E. A, Optimized unit cell of Li₃SBF₄. The arrow indicates the C₃ᵥ orientational symmetry adopted by the BF₄⁻ tetrahedral unit in the cubic cell. The black outline highlights the pyramidal configuration of Li₃S⁺. B, Calculated phonon spectra of the studied super-LRAP. Also shown are the positions of the quasi rigid unit modes (q-RUMs) in the spectra of Li₃SBF₄ and Li₃OBH₄. C, HSE06 calculated DoS of the studied super-LRAP. The Fermi level is set to zero in each case. D, Calculated radial distribution functions of Li₃SBF₄ using MD trajectory data over 100 ps at 400 and 600 K under ambient pressure. E, Estimated range of ratio between the ionic conductivity of Li₃SBF₄ and that of Li₃OBH₄ at RT by using the energy of the q-RUMs of these materials in a simple Einstein model. n_{LSBF} and n_{LOBH} are the mean phonon occupation number at room temperature T_{R} of Li₃SBF₄ and Li₃OBH₄, respectively.

FIGS. 4A and B. A, The model used to study the relation between the rotation of the BF₄⁻ units and the interaction potential felt by the Li⁺ ion as it migrates from A₁ site to A₂ site. Each Li site is coordinated by four BF₄⁻ units. Curve 1 and curve 2 show two possible potential profiles along the migration pathway, created by the rotation of the BF₄⁻ units. B, Calculated potential surfaces in an area of 1.0 Å×1.0 Å around the Li⁺ site for different orientational symmetries of the BF₄⁻ tetrahedra. The C₃ᵥ symmetry generates the lowest potential of the order of −10⁻² V.

FIGS. 5A and B. A, The MD simulations to study the Li⁺-ion superionic conductivity of Li₃SBF₄. A 2×2×2 supercell with one Li⁺ vacancy (in open circle) is used. The MSD and the diffusion coefficients are calculated at 550, 650, 750, 900 and 1000 K. (b) The MD simulations to study the Li⁺-ion superionic conductivity of Li₃S(BF₄)_{0.5}Cl_{0.5}. A 2×2×2 supercell with one Li⁺ vacancy (in open circle) is used. The MSD and the diffusion coefficients are calculated at 450, 600, 700, 800 and 900 K.

FIG. 6. Schematic representation of an exemplary solid state battery, which may be included in a device or vehicle.

### DETAILED DESCRIPTION

Described herein are superionic conductors that exhibit improved three-dimensional RT Li⁺ conductivities and improved activation energies. The materials represent a new family of lithium-rich antiperovskites composed of cluster ions such as Li₃O⁺/Li₃S⁺ and BH₄⁻/AlH₄⁻/BF₄⁻. The new family is called super-LRAP, because the cluster cations are super-alkalis and the cluster anions are super-halogens.

### Definitions

Activation energy: refers to the amount of energy required for an ion to “hop” within an otherwise rigid crystal structure.

Antiperovskite: a material with a crystal structure similar to the perovskite structure but in which the positions of the cation and anion constituents are reversed in the unit cell structure. In contrast to perovskite, in antiperovskite compounds, two types of anions are coordinated with one type of cation.

Perovskite: a material with the same type of crystal structure as calcium titanium oxide (CaTiO₃), known as the perovskite structure, or XII_{A}²⁺VI_{B}⁴⁺X²⁻₃ with the oxygen in the face centers. In perovskite materials, two types of cations are coordinated with one type of anion.

Band gap: the energy difference between the top of the valence band and the bottom of the conduction band in a material. Electrons are able to jump from one band to another, but in order for an electron to jump from a valence band to a conduction band, a specific minimum amount of energy is required for the transition. The required energy differs with different materials. Electrons can gain enough energy to jump to the conduction band by absorbing either a phonon (heat) or a photon (light).

Channel size: the space available for a cation (such as Li⁺) to migrate in a cluster cation.

Fast ion conductors are solids with highly mobile ions. These materials are important in the area of solid-state ionics, and are also known as solid electrolytes and superionic conductors. As solid electrolytes they allow the movement of ions without the need for a liquid or soft membrane separating the electrodes. The phenomenon relies on the movement of ions through an otherwise rigid crystal structure.

Ion hopping: refers to the process of when an ion jumps (moves, transitions, etc.) from its normal position in a crystal lattice to a neighboring, vacant, lattice site.

Rigid unit modes (RUMs) represent a class of lattice vibrations or phonons that exist in network materials i.e. three-dimensional networks of polyhedral groups of atoms such as tetrahedral, octahedral, etc. A RUM is a lattice vibration in which the polyhedra are able to Quasi-RUMs: phonons that almost act as RUMs.

Solid-state electrolytes used primarily to distinguish from electrolyte formulations where the formulation is an entirely liquid phase, almost entirely liquid phase, or substantially liquid phase.

Superhalogens: ion clusters in which the vertical electron detachment energies of the moieties that make up the negative ions are larger than that of any halogen atom.

Super-alkalis: ion clusters with ionization potentials smaller than that of alkali elements.

Vertical detachment energy (VDE): the minimum energy needed to remove (eject) an electron from a negative ion in its ground (electronic and vibrational) state.

Super-alkali cluster cations (generally Li⁺ and/or Na⁺ super-alkali cluster cations) that may be employed in the superionic conductor materials described herein include but are not limited to: Li₃O⁺, Li₃S⁺, Na₃O⁺ and Na₃S⁺. Super-halogen cluster anions that may be employed in the superionic conductor materials described herein include but are not limited to: BH₄⁻, AlH₄⁻, BF₄⁻ and BCl₄⁻. In some aspects, a single superionic conductor material comprises a particular type of cluster anion above. For example, the material is formed from Li₃S⁺ and BF₄⁻, i.e. the material is Li₃SBF₄.

In some aspects, the superionic conductor material is a “mixed” superionic conductor material in which the super-halogen cluster anions are partially replaced by halogen anions. Examples of halogen anions that can replace a super-halogen cluster anion include but are not limited to: Cl, Br and I. One type of halogen or more than one type of halogen may be used in a material. Generally, the percentage of super-halogen cluster anions that are replaced in the material is from about 0% to about 100%, and usually about 50% is the optimal ratio. The best choice of ratio depends on the realization of the highest stability and highest ionic conductivity of the resulting material.

For example, the material is formed from Li₃S⁺, BF₄⁻ and Cl⁻ i.e. the material is Li₃S(BF₄)_{0.5}Cl_{0.5}.

The solid-state electrolyte materials described herein have several advantageous properties. For example, the material exhibits a band gap of at least about 4.0 eV, e.g. about 3.5, 4.0, 4.5, 5.0, 5.5, 6.0, 6.5, 7.0, 7.5. 8.0 and 8.5 or even 9.0 eV. In some aspects, the band gap is about 7.0 eV; in other aspects, the band gap is about 8.5 eV.

In addition, the material exhibits an activation energy that is generally about 0.25 eV or less, e.g. about 0.0, 0.29, 0.28, 0.27, 0.26, 0.25, 0.24, 0.23, 0.22, 0.21, 0.20 eV or less, e.g. about 0.190, 0.185, 0.180, 0.175, 0.170, 0.165 or 0.160. In some aspects, the activation energy is about 0.210 eV or about 0.176 eV.

The room temperature (RT) conductivity of the material is generally about 10⁻³ S/cm or greater, for example, about 10⁻⁴, 10^{-3.5}, 10^{-3.0}, 10^{-2.5}, 10^{-2.0}, 10^{-1.5} or 10^{-1.0} S/cm. In some aspects, the RT conductivity is 10⁻³ S/cm, 10⁻² S/cm or 10⁻¹ S/cm.

The melting point of the solid superionic conductor material disclosed herein is also favorable, being at least about 400, 450, 500, 550 or 600K, and typically at least about 600 K or greater, such as 650 or 700K.

In addition, the disclosed materials had favorable mechanical properties such as lightness, large shear modulus and flexibility. For example, compared to the atomic mass of Cl which is 35 amu (atomic mass unit), the atomic masses of the cluster ions BH₄ and BF₄ are only 14 and 24 amu, respectively, resulting in the lightness of the disclosed materials. There is a threshold for the shear modulus above which the dendric growth of a Li metal anode can be inhibited by a solid electrolyte. This threshold is four times the shear modulus of the Li metal, which is about 35 GPa. The shear modulus of Li₃SBF₄ is 46 GPa which is well above the threshold. The calculated Young's modulus of Li₃SBF₄ is about 142 GPa which is between those of copper and mild steel. The Poisson's ratio of the material is about 0.1 which is between those of a metal and carbon fiber.

### Producing the Solid Electrolyte

The solid electrolyte compositions described herein are prepared as follows: Salts (e.g. powders that are commercially available) with the elements of super-alkali and the super-halogen are mixed and reacted. Ball-milling (e.g. to reduce size), temperature and pressure may be applied to facilitate the reaction (e.g. to overcome energy barriers, etc.). For example, in the case of Li₃SBF₄, Li₂S and LiBF₄ may be used to produce the desired product. The calculated formation energy of Li₃SBF₄ antiperovskite for the reaction LiBF₄+Li₂S→Li₃SBF₄ is 39.4 meV/atom which is significantly lower than 58.8 meV/atom of the antiperovskite Li₃OBH₄(LiBH₄+Li₂O→Li₃OBH₄) and is close to those of Li₃OA (LiA+Li₂O→Li₃OA)—13.9 and 25.8 meV/atom for A=Cl and Br, respectively. Thus, preparation strategies similar to those used for Li₃O may be employed (e.g. as described in Zhao, et al. J. Am. Chem. Soc. 134, 15042-15047 (2012)), as long as the starting materials and novel combinations thereof as described herein are used.

### Batteries

Embodiments of the present invention include lithium ion batteries comprising electrode active materials, e.g. having an anode (anode active material), a cathode (cathode active material), and a solid-state electrolyte as described herein, i.e. a cluster-ion based lithium superionic conducting material. (Those of skill in the art will recognize that the electrochemical roles of the electrodes reverse between anode and cathode, depending on the direction of current flow through the cell.) The anode active material layer may further contain at least one of a solid electrolyte material, a conductive material, and a binder other than the anode active material. The cathode active material may further contain at least one of a solid electrolyte material, a conductive material, and a binder other than the cathode active material. The cathode and anode active materials may be in a shape such as a granular shape or a thin film shape.

In certain preferred embodiments, the solid-state electrolyte comprises i) Li or Na super-alkali cluster cations; ii) super-halogen cluster anions; and, optionally, iii) halogen anions, and has an antiperovskite crystal structure.

The solid-state batteries formed using the solid electrolyte formulations disclosed herein can be used with electrode configurations and materials known for use in solid-state batteries. In such batteries, the active material for use in the cathode can be any active material or materials useful in a lithium ion battery cathode, including, for example, metal oxides such as lithium metal oxides or layered oxides, lithium-rich layered oxide compounds, lithium metal oxide spinel materials, olivines, etc. Preferred cathode active materials include lithium cobalt oxides and lithium layered oxides. Active materials can also include compounds such as silver vanadium oxide (SVO), metal fluorides (e.g., CuF₂, FeF₃), and carbon fluoride (CFx). More generally, the active materials for cathodes can include phosphates, fluorophosphates, fluorosulfates, silicates, spinels, and composite layered oxides. In some aspects, the cathode material comprises or is: lithium manganese oxide (LiMn₂O₄), lithium manganese nickel oxide (LiMn_{1.5}Ni_{0.5}O₄), cobalt monoantimonide (CoSb), lithium cobalt(III) oxide (LiCoO₂), lithium cobalt phosphate (LiCoPO₄), lithium iron(III) oxide (LiFeO₂), lithium iron(II) phosphate (LiFePO₄), lithium iron(II) silicate (Li₂FeSiO₄), lithium manganese dioxide (LiMnO₂), lithium manganese nickel oxide (Li₂Mn₃NiO₈), lithium manganese oxide (LiMn₂O₄), lithium nickel cobalt aluminum oxide (LiNi_{0.8}Co_{0.15}Al_{0.05}O₂), lithium nickel cobalt oxide (LiNi_{0.8}Co_{0.2}O₂), lithium nickel dioxide (LiNiO₂), lithium nickel manganese cobalt oxide (LiNi_{0.33}Mn_{0.33}Co_{0.33}O₂), manganese nickel carbonate (Ni_{0.25}Mn_{0.75}CO₃), etc. The finished cathode can also include a binder material, such as poly(tetrafluoroethylene) (PTFE) or poly(vinylidene fluoride (PVdF).

The materials for use in the anode can be any material or materials useful in a lithium ion battery anode, including lithium-based, silicon-based, titanium based oxides and carbon-based anodes. In some aspects, the negative electrode (anode) is carbon-based and may be, for example, natural or artificial graphite (e.g. graphite coated on copper foil), activated carbon, carbon black, or high-performance powdered graphene. In other aspects, the anode is formed from another material such as LTO (lithium titanate), surface-functionalized silicon, hollow a Fe₃O₄ nano material, tin, a ternary metal vanadate, an alloy such as an Al alloy, etc.

Various other solid and composite materials for use in electrodes in solid state batteries are described in published US patent applications 2017/0338470, 2017/0352907, 2017/0373317 and 2018/0006326, the complete contents of each of which is herein incorporated by reference. Methods and designs for assembling and arranging the elements of solid state batteries are also known, such as those set forth in published US patent applications 2017/0352907, 2017/0331156 and 2017/0356078, the complete contents of each of which is herein incorporated by reference, except that the electrolytes/solid electrolytes discussed therein are replaced by those of the present disclosure.

In addition, the solid electrolytes described herein can be used in hybrid battery technologies that utilize both solid and liquid electrolytes together.

Designs for and methods of making solid-state batteries are known in the art and include a wide range e.g. from small, coin shaped batteries to large batteries e.g. in a series for use in an automobile, and thin film lithium ion batteries. See, for example, published US patent applications 2018/0026301, 2017/0352923, 2017/0356078, 2017/0271649, which can be adapted to use the solid electrolytes disclosed herein, as well as issued U.S. Pat. Nos. 9,843,071 and 9,799,933, the complete contents of each of which is hereby incorporated by reference in entirety.

One or more current collectors are generally also present in a solid state battery. Current collectors are comprised of, for example, chromium nitride, Cu, Al, Ru, TiN, etc.

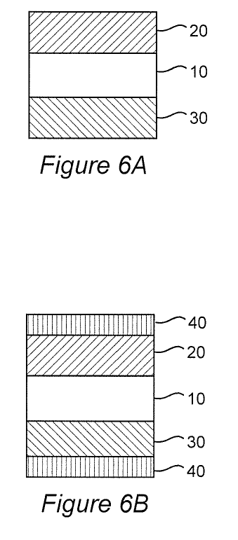

A schematic representation of an exemplary solid state battery is provided in FIG. 6. As shown, such a battery comprises solid electrolyte 10 anode 20 and cathode 30, the entirety of which is generally surrounded by a housing (e.g. an insulated housing, not shown). FIG. 6B shows a similar depiction but two layers of current collector 40 are depicted. Those of skill in the art will recognize that multiple stacks of the layers shown in e.g. FIG. 6B may also be present.

### Uses of Materials Described Herein

The superionic conducting materials described herein are useful for a wide variety of applications including but not limited to: various electrochemical devices such as batteries and super capacitors, sensors, fuel cells, conductive fabrics, etc.

In particular, the solid state batteries disclosed herein find use in a variety of technologies and devices that require energy storage and/or which are rechargeable, especially portable devices, and such technologies/devices are also encompassed. For example, solid state batteries (e.g. secondary batteries) comprising the disclosed solid electrolytes are used in a wide variety of technologies, examples of which include but are not limited to: cell phones, electric vehicles (e.g. electric cars, buses, motorcycles, trucks, etc.), computers, home appliances, various elements of the Internet of things, medical monitoring and sensing devices (e.g. pacemakers, hearing aids, etc.), toys and devices used in space, etc. All such devices which comprises one or more solid electrolytes as disclosed herein, and/or which comprise a solid state or hybrid battery comprising one or more of the solid electrolytes, is encompassed by the present disclosure.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

Enjoying great safety, high power and high energy densities, all-solid-state batteries play a key role in the next generation energy storage devices. However, their development is limited by the lack of solid electrolyte materials that can reach the practically useful conductivities of 10⁻² S/cm at room temperature (RT). Here, by exploring a new family of lithium-rich antiperovskites composed of cluster ions, we report the discovery of a lithium superionic conductor, Li₃SBF₄, that has an estimated three-dimensional RT conductivity of 10⁻² S/cm, a low activation energy of 0.210 eV, a giant band gap of 8.5 eV, a small formation energy, a high melting point and desired mechanical properties. A mixed phase of the material, Li₃S(BF₄)_{0.5}Cl_{0.5}, with the same simple crystal structure, exhibits a RT conductivity as high as 10⁻¹ S/cm and a low activation energy of 0.176 eV. The high ionic conductivity of the materials is enabled by the thermal-excited vibrational modes of the cluster ions and the large channel size created by mixing the large cluster ion with the small elementary ion.

In this example, we describe superionic conductors that exhibit improved three-dimensional RT Li⁺ conductivities and improved activation energies. The materials represent a new family of lithium-rich antiperovskites composed, for example, of cluster ions, Li₃O⁺/Li₃S⁺ and BH₄⁻/AlH₄⁻/BF₄⁻. The new family is called super-LRAP, because the cluster cations, with ionization potentials smaller than that of alkali elements, are called super-alkalis while the cluster anions, with vertical detachment energies larger than that of halogen elements, are called super-halogens. We show that a lithium superionic conductor Li₃SBF₄ with a simple crystal structure has an estimated RT conductivity of 10⁻² S/cm and an activation energy of 0.210 eV. The material also exhibits a giant band gap around 8.5 eV, a high melting point over 600 K, a small formation energy less than 40 meV/atom and favorable mechanical properties. By partially replacing the super-halogen ion BF₄⁻ with chlorine, the mixed phase material, Li₃S(BF₄)_{0.5}Cl_{0.5}, shows a stellar conductivity over 10⁻¹ S/cm at RT and an activation energy as low as 0.176 eV.

The discovery of the super-LRAP family is guided by a set of recently synthesized lithium-rich antiperovskites Li₃OA (A=halogen). As solid electrolytes, these conductors exhibit improved properties from A=I to Cl, with Li₃OCl showing the highest Li⁺ conductivity at RT (0.85×10⁻³ S/cm), the lowest activation energy of 0.303 eV and the largest band gap of about 5 eV among the series. In the halogen group, Cl provides the optimal radius ratio against oxygen and lithium. Consequently, the stabilized antiperovskite structure of Li₃OCl possesses the largest channel size, defined as the available space for Li⁺ to migrate, among the group elements. The results are shown in Table I. The valence band maximum (VBM) of Li₃OA (A=halogen) corresponds to the valence orbital of the halogen. Among all the halogen elements, chlorine has the highest vertical detachment energy (VDE)—defined as the energy needed to remove an electron from Cl⁻. This suggests that the valence orbital of chlorine and hence the VBM of Li₃OCl lies at the lowest energy in the group, causing Li₃OCl to have the largest band gap. Based on these arguments, if some halogens having higher VDE than that of chlorine could exist in the periodic table, the antiperovskites stabilized by such halogens should have larger band gaps than that of Li₃OCl. Since band gap provides an upper limit of electrochemical stability window (ESW), a larger band gap is preferred for a solid electrolyte. Moreover, by finding a halogen with the right ionic radius, larger channel size and higher ionic conductivity compared to Li₃OCl may also be achieved. However, the periodic table is limited and does not provide the needed flexibility.

In this Example, we show that there is indeed a way to go beyond the periodic table to find a “halogen” (i.e. a “super-halogen”) that would lead to an electrolyte with better performance than Li₃OCl. Super-halogens and super-alkalis belong to a sub-group of “super-atoms”. The super-halogen ion BH₄⁻ with four hydrogen atoms tetrahedrally bonded to one boron is a good example. As described herein, we have now studied the use of BH₄⁻ to make new lithium-rich antiperovskites. Given that BH₄⁻ has an ionic radius very similar to Br⁻, we show that the super-halogen stabilizes the antiperovskite structure to make Li₃OBH₄, a lithium superionic conductor with a RT conductivity similar to that of Li₃OCl. The higher VDE of BH₄⁻ produces a larger band gap of 7.0 eV in Li₃OBH₄ compared to that in Li₃OCl.

TABLE I
Key information about the cluster ions in the super-LRAP family. In
each case, the channel size (CS) is calculated using the volume of the
unit cell minus the volumes of all the ions inside. The used ionic
radii (R) of Li, O, S, B, Al, H and F are 0.90, 1.26, 1.70, 0.41, 0.68, 0.81
and 1.01 Å, respectively. The volume of a super-halogen ion is
defined as the volume of the cube enclosing the super-halogen tetrahedron.
The value in the parenthesis is the calculated bonding ionicity (BI),
measured by the value of the VDE of the super-halogen ions
AlH₄⁻/BH₄⁻/BF₄⁻/minus the IP of the super-alkali ions
Li₃O⁺/ Li₃S⁺/(3.88/3.72 eV) in (Li₃S)(AlH₄),
(Li₃O)(BH₄), (Li₃S)(BF₄), (Li₃O)Cl and (Li₃O)Br. (Li₃S)(BF₄)
has the largest bonding ionicity of all. “t” is the calculated
Goldschmidt's tolerance factor. BL is the bond length inside the
super-halogens. LP is the calculated lattice parameters of the
corresponding crystal.

| | VDE | BL | BL | | CS | | |
|---|---|---|---|---|---|---|---|
| | (BI) | (cluster) | (crystal) | | (Å³/unit | LP | |
| | (eV) | (Å) | (Å) | R (Å) | cell) | (Å) | t |
| AlH₄⁻ | 4.46 (0.73) | 1.64 | 1.67 | 2.66 | 56.27 | 4.73 | 1.03 |
| BH₄⁻ | 4.44 (0.56) | 1.24 | 1.22 | 2.03 | 42.74 | 4.00 | 1.04 |
| BF₄⁻ | 7.42 (3.69) | 1.44 | 1.42 | 2.43 | 62.48 | 4.72 | 1.10 |
| Cl⁻ | 3.71 (−0.17) | — | — | 1.67 | 31.89 | 3.91^{a} | 1.19 |
| Br⁻ | 3.58 (−0.30) | — | — | 1.82 | 31.33 | 4.02^{a} | 1.12 |

^{a}Experimental values from Zhang, et al. Phys. Rev. B 87, 134303 (2013).

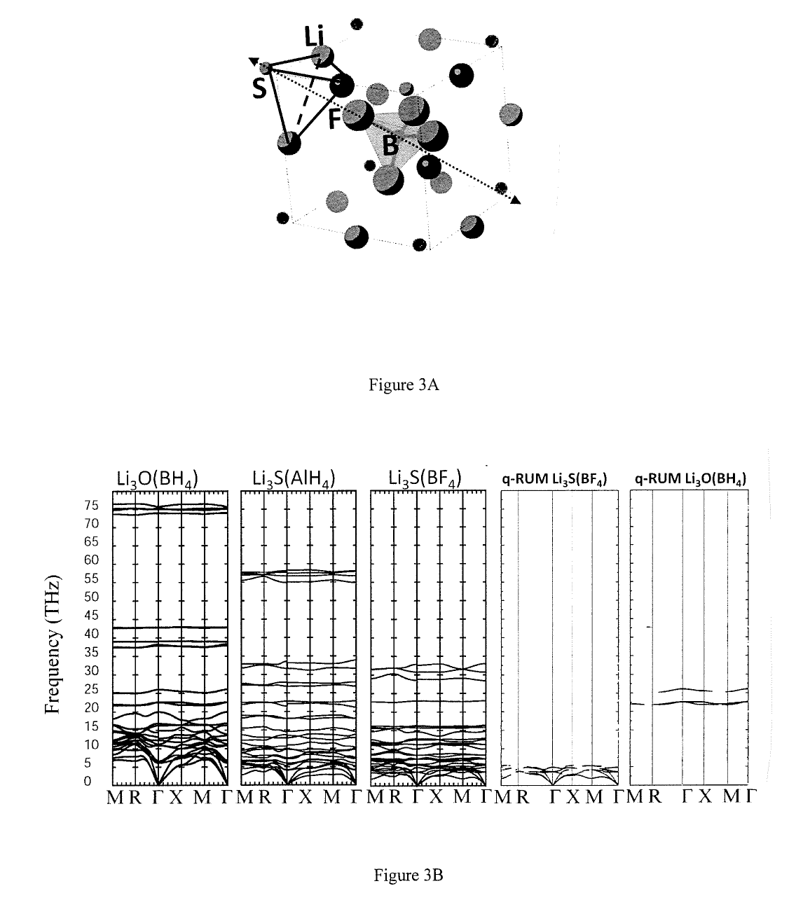

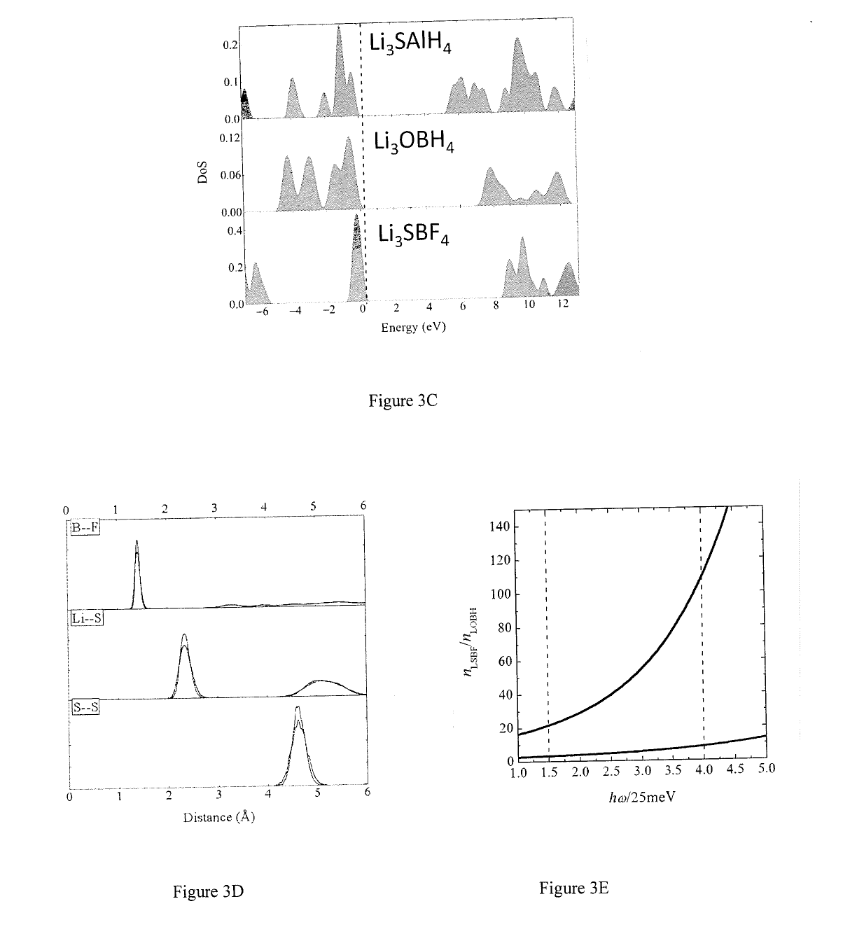

In addition to BH₄⁻, there are other super-halogen ions such as AlH₄⁻ and BF₄⁻ that have different sizes and VDEs. One can define the ionic radius of a super-halogen ion as the sum of the bond length of M-Y (M=Al, B; Y=H, F) and the ionic radius of Y (Y=H, F). The bond lengths and the calculated ionic radii of the super-halogens are given in Table I. Note that the ionic radii of both AlH₄⁻ and BF₄⁻ are significantly larger than that of BH₄⁻. According to a simple geometric consideration, the Goldschmidt tolerance factor for the antiperovskite Li₃OX is given as,

$$t = \frac{\sqrt{2} ( {r}_{A} + {r}_{C} )}{{r}_{B} + {r}_{C}} , \qquad ( 1 )$$

where r_{A} is the ionic radius of oxygen, r_{B} the radius of X and r_{C} the radius of lithium ion. In order to stabilize the antiperovskite structure with X being large super-halogen ions, such as AlH₄⁻ and BF₄⁻, the oxygen atom should be replaced by a larger group element such as sulfur. The resulting materials are Li₃SAlH₄ and Li₃SBF₄. As shown in Table I, Li₃SAlH₄, Li₃OBH₄ and Li₃SBF₄ all have a tolerance factor around 1.0 with BF₄⁻ generating a tolerance factor closer to those of Li₃OA (A=halogen). This suggests the high ability of BF₄⁻ to stabilize the structure. Studies of the phonon spectra (FIG. 3B) confirm that all these materials are lattice-dynamically stable in the antiperovskite structure. The calculated formation energy of Li₃SBF₄ antiperovskite for the reaction LiBF₄+Li₂S→Li₃SBF₄ is 39.4 meV/atom which is significantly lower than 58.8 meV/atom of the antiperovskite Li₃OBH₄ (LiBH₄+Li₂O→Li₃OBH₄) and is close to those of Li₃OA (LiA+Li₂O→Li₃OA)—13.9 and 25.8 meV/atom for A=CI and Br, respectively].

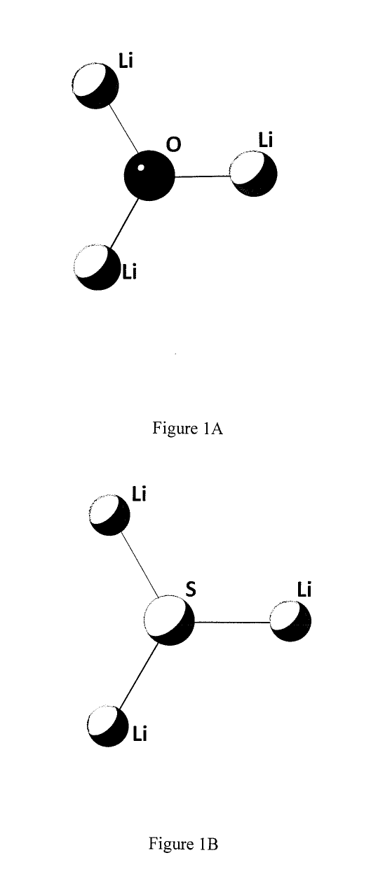

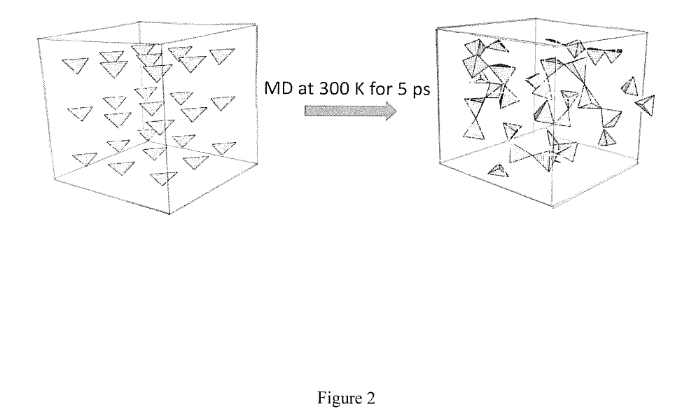

Interestingly, the cluster Li₃S, like Li₃O, is a super-alkali as its ionization potential (IP) is lower than that of lithium. Isolated Li₃S⁺/Li₃O⁺ has a planar configuration (FIG. 1). However, when they interact with each other, they flip like an umbrella, adopting a pyramidal configuration, as shown by molecular dynamics(MD) simulation in FIG. 2. The pyramidal configuration is like that which is observed in the antiperovskite crystal (as shown by the black-edge shape in FIG. 3A). This is due to the attraction (repulsion) between the three positive lithium atoms (the lone pair on oxygen/sulfur) of one Li₃S⁺/Li₃O⁺ and the lone pair on oxygen/sulfur of its neighboring Li₃S⁺/Li₃O⁺. Thus, one may also view the antiperovskites (Li₃S/O)⁺X⁻ (X=AlH₄, BH₄, BF₄) as ionic crystals of alkali halides (e.g. CsCl). This analogy suggests that the larger the VDE of the super-halogen X, the larger is the band gap of (Li₃S/O)⁺X⁻. Recall that the band gap of alkali halides is determined by the bonding ionicity which can be measured by the value of the VDE of (super-)halogen minus the IP of (super-)alkali. As shown in Table I, since BF₄⁻ has the largest VDE and, hence, the largest bonding ionicity with Li₃S⁺, crystal (Li₃S)(BF₄) is expected to have the largest band gap among the studied materials. Indeed, the electronic density of states (DoS) of Li₃SBF₄ in FIG. 3C, calculated using the HSE06 functional, show the largest band gap of 8.5 eV compared to the 5.0 eV of Li₃SAlH₄, 7.0 eV of Li₃OBH₄ and those of Li₃OA (A=halogen). Such value of band gap is much larger than any of the known solid electrolytes with high Li⁺ conductivity. For example, the calculated band gap of Li₁₀GeP₂S₁₂ is only 3.6 eV and its observed ESW of 5 V is likely due to some passivation phenomenon. The valence band of Li₃SBF₄ is contributed by sulfur and BF₄⁻ and the conduction band has contributions from lithium and BF₄⁻. This makes a good analogy to those of Li₃OA, where the valence band is contributed by oxygen and halogen A=Cl/Br and the conduction band is contributed by lithium and Cl/Br.

The thermal stability of the super-LRAP, i.e. Li₃SAlH₄, Li₃OBH₄ and Li₃SBF₄, was tested by MD simulations at constant temperature and pressure. The radial distribution functions are calculated using the MD trajectory data collected over 100 ps. As shown in FIG. 1D for Li₃SBF₄, no melting is observed up to 600 K. The calculated linear thermal expansion coefficient of Li₃SBF₄ from the MD data is 1.6×10⁻⁵/K which is smaller than 3.0×10⁻⁵/K of Li₃OBH₄. The value is also smaller than 2.1×10⁻⁵/K and 1.8×10⁻⁵/K of Li₃OA for A=Cl and Br, respectively. This should be considered as another advantage of Li₃SBF₄: a smaller thermal expansion means a higher compatibility with other parts inside a composite device subject to large temperature fluctuations.

The magnitude of Li⁺ conductivity of the (super)-LRAP may be indicated by the channel size, i.e. the space available for Li⁺ to migrate inside the material. By considering the volume of the unit cell and the volume of the ions inside, we calculated the channel size for each material as shown in Table I. Li₃OCl has a larger channel size than Li₃OBr, which is consistent with the experimentally observed higher Li⁺-ion conductivity of the former compared to the latter. Li₃SBF₄ provides a much larger channel size compared to the rest, which may be due to the highly negative charge distributed on each F (−1.9e) of BF₄⁻ compared to the charge on each H (−0.8e) of AlH₄⁻ and on each H (−0.6e) of BH₄⁻, making more room between sulfur and BF₄⁻ in the crystal to reduce the repulsion. In addition, the interaction between sulfur and Li⁺ is known to be significantly lower than that between oxygen and Li⁺. All these results suggest that Li₃SBF₄ should exhibit a much higher Li⁺-ion conductivity than the other materials.

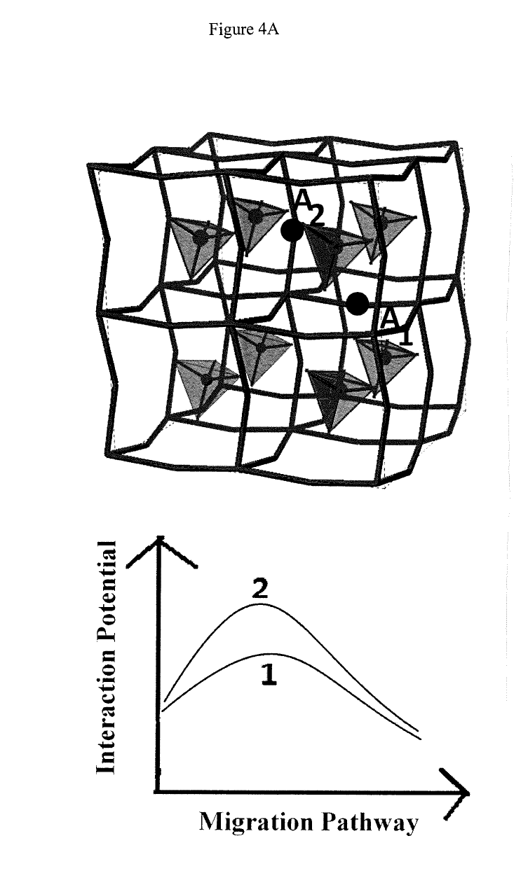

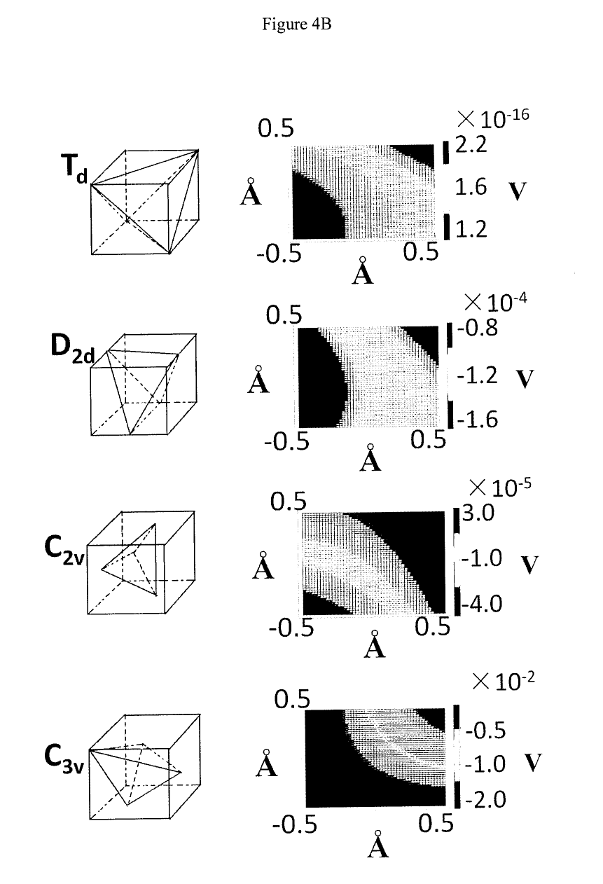

From studies of Li₃OA (A=halogen) and Li₃OBH₄, we understand that the Li⁺ conductivity in the super-LRAP is triggered by the Li⁺-vacancy defect and is correlated to the translational and rotational modes of the super-halogen ions. Upon thermal excitation, these modes can constantly change the orientations of the super-halogen tetrahedra from their ground state symmetry of C₃ᵥ as shown in FIG. 3A. This in turn generates a shifting and varying potential surface throughout the crystal which can then facilitate fast-ion migration of Li⁺ between different sites. For Li₃SBF₄, these are shown in a modeled system in FIG. 4A. Each Li⁺ ion is coordinated by four BF₄⁻ tetrahedral units. When the Li⁺ ion migrates from site A₁ to A₂, rotation of the BF₄⁻ units can generate a preferred potential profile along the pathway, as shown in FIG. 4A by comparing the potential curve 1 to 2. To quantify the relation between the motions of the four BF₄⁻ units and the potential surface created by them at the Li⁺ site, we calculated the dipole plus quadrupole terms of the potential according to different orientational symmetries of BF₄⁻ (see the Methods section). As shown in FIG. 4B, the orientation with C₃ᵥ symmetry generates the lowest potential of −10⁻² V, while the other high-symmetry orientations generate practically zero dipole plus quadrupole terms. In each case, the varying magnitude of the potential surface in an area of 1.0 Å×1.0 Å around the Li⁺ site demonstrates the effect of the translational motions of the BF₄⁻ units.

The vibrational modes involving the translations and rotations of the super-halogen ion as a “rigid” body are more important, since any large distortion of the super-halogen itself will make the modes high in energy, making them less relevant to the conductive property at room and medium temperatures. One way to pinpoint the important modes originating from motions of the super-halogen ion with no or small distortion is to find out the so-called quasi rigid unit modes (q-RUMs) by mapping the lattice-dynamic eigenvectors of a model system with the super-halogens as rigid bodies onto the real phonon eigenvectors of the material. The vibrational modes that are q-RUMs are shown in FIG. 3B for Li₃SBF₄ and Li₃OBH₄. It is found that all the q-RUMs are in the range of 2.5 to 10 THz for Li₃SBF₄ and 5.0 to 25 THz for Li₃OBH₄. According to the conduction mechanism of super-LRAP discussed before, at certain temperatures, as more of the q-RUMs (translational and rotational modes of the super-halogen units) are thermally excited, a higher number of favorable potential profiles for Li⁺ to migrate will be present and more Li⁺ will pass through per unit area per unit time. This will result in higher diffusion coefficient, given a certain gradient of the Li⁺ concentration. In other words, the Li⁺ conductivity at a certain temperature should be proportional to the diffusion coefficient and, therefore, proportional to the number of excited q-RUMs at that temperature. In a simple Einstein model, the mean phonon occupation number at temperature T is

$$n = \frac{1}{exp ( ℏ {ω}_{E} \text{/} {k}_{B} T ) - 1} , \qquad ( 2 )$$

where ω_{E} is the Einstein frequency which should serve as a characteristic frequency of the q-RUMs here. Thus, we can compute the ratio between the mean phonon occupation number of Li₃SBF₄ (LSBF) and that of Li₃OBH₄ (LOBH) at temperature T as,

$$r = \frac{{n}_{LSBF}}{{n}_{LOBH}} = \frac{1}{exp ( c ℏ {ω}_{E} \text{/} {k}_{B} T )} \text{/} \frac{1}{exp ( ℏ {ω}_{E} \text{/} {k}_{B} T )} , \qquad ( 3 )$$

where the coefficient c is the ratio between the Einstein frequency of Li₃SBF₄ and that of Li₃OBH₄. Here, we do not know the exact value of the Einstein frequency ω_{E}. However, with knowledge of the energy range of the q-RUMs of Li₃SBF₄ (2.5-10 THz) versus that of Li₃OBH₄ (10-25 THz), we can estimate a range of ratio r according to Eq. (3) by assuming a lower limit of the coefficient c=2.5/25=1/10 and an upper limit of c=2.5/5.0=1/2. The resulting range of r at room temperature (300 K˜25meV) for ℏω_{E}=3⁷ to 100 meV (ω_{E}=9 to 25 THz) is shown by the shaded area in FIG. 3E. According to the previous discussions, r should measure the ratio between the Li⁺ conductivity of Li₃SBF₄ and that of Li₃OBH₄ at RT. Thus, as indicated by FIG. 3E, it is predicted that Li₃SBF₄ will exhibit a much higher RT conductivity—from several (˜3) up to over 100 times higher than those of Li₃OBH₄ and Li₃OCl (since Li₃OBH₄ shows a similar ionic conductivity with Li₃OCl).

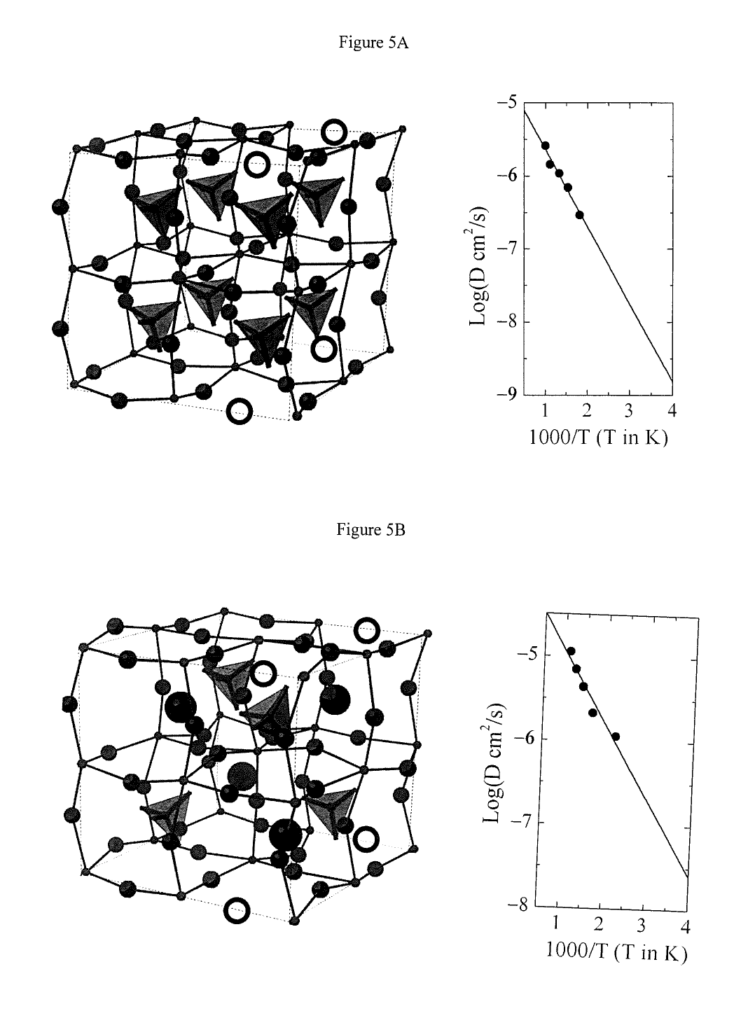

Both the calculated channel size and the study of q-RUMs of the materials suggest that Li₃SBF₄ should have a much higher ionic conductivity compared to the others. To provide a quantitative estimation of the conductivity of Li₃SBF₄, we carried out MD simulations at 550, 650, 750, 900 and 1000 K over 130 ps using a supercell with one Li⁺ vacancy shown in FIG. 5A (see the Methods Section). The mean square displacement (MSD) of Li⁺ ions are calculated from the MD trajectory data. The Li⁺ diffusion coefficient (D) at each temperature is obtained by a linear fit to the MSD. The Arrhenius model is then used to fit to the values of D at different temperatures to obtain the conductivity at RT and the activation energy. These are shown in FIG. 5A. Compared to the calculated activation energy of 0.303 eV and the RT conductivity 0.12×10⁻³ S/cm of Li₃OCl with the same theoretical method, the calculated activation energy of Li₃SBF₄ is 0.210 eV and its RT conductivity is 0.14×10⁻² S/cm, which is about 12 times higher and which falls well within the predicted range in FIG. 3E. It is known that the absolute value of the calculated conductivity will be significantly underestimated by the theoretical method here, due to the fixed volume in the MD simulations. However, such methods do reproduce the correct activation energy and the right ratio between the conductivities of materials. Given that the experimentally observed RT conductivity of Li₃OCl is 0.85×10⁻³ S/cm, it is expected that Li₃SBF₄ can reach a RT conductivity of 1.0×10⁻² S/cm (12 times of 0.85×10⁻³ S/cm), a value that is the same as that of the organic liquid electrolyte used in conventional batteries. The low activation energy (0.210 eV) of Li₃SBF₄ enables very high ionic conductivities at low temperatures, which is considered to be an advantage of solid electrolytes over liquid electrolytes. At −30° C. (˜243 K) for example, the conductivity of Li₃SBF₄ is still about 1.7 times the RT conductivity of Li₃OCl, suggesting a value over 10⁻³ S/cm. This should allow batteries to operate at very low temperatures. At high temperatures below the melting point, for instance 500 K, the ionic conductivity of Li₃SBF₄ is expected to be well above 10⁻¹ S/cm.

It is expected that, by partially replacing BF₄⁻ with Cl⁻ inside Li₃SBF₄ to make Li₃S(BF₄)₁₋ₓClₓ (0<x<1), the Li⁺ superionic conductivity will be further increased. The reason is that, by putting the elementary halogen and the large super-halogen together in the same structure, the lattice maintains a large size to accommodate the super-halogen (BF₄⁻), resulting in large redundant space around the halogen (Cl⁻) site. This provides Li⁺ with an unusually large space to migrate in the halogen-containing cells, while keeping the original conductivity for the cells containing the super-halogens.

Indeed, in the present study of Li₃S(BF₄)_{0.5}Cl_{0.5}, as shown in FIG. 5B, the optimized volume of the mixed phase is only 5% smaller than that of the pure Li₃SBF₄ system and the calculated channel size of the former is 69.07 Å³/unit-cell which is significantly higher than that of Li₃SBF₄ (62.48 Å³/unit-cell) and much larger than that of Li₃OCl (31.89 Å³/unit-cell). We further calculated the Li⁺ conductivity of Li₃S(BF₄)_{0.5}Cl_{0.5} using MD simulations at 450, 600, 700, 800 and 900 K. The results are shown in FIG. 3b. The calculated RT conductivity is 1.9×10⁻²S/cm which is already higher than the conductivity of the organic liquid electrolytes. Considering that the value is about 14 times higher than the calculated value of Li₃SBF₄, it is expected that the real RT conductivity of Li₃S(BF₄)_{0.5}Cl_{0.5} could be well above 10⁻¹ S/cm, a value that is more than 10 times higher than that of the organic liquid electrolytes. The material also has an extremely low activation energy of 0.176 eV which leads to a calculated conductivity of 0.38×10⁻² S/cm at −30° C. or about 19 times higher than that of Li₃SBF₄ (0.20×10⁻³ S/cm). This suggests that the real conductivity of the material should be well above 10⁻² S/cm at such a low temperature.

TABLE II
Calculated elastic tensors and constants (in GPa)
as well as Poisson's ratio of Li₃SBF₄ from the
acoustic branches (see the Method section).

| | | | |
|---|---|---|---|
| c₁₁ | 138 | Poisson's ratio (υ) | 0.1 |
| c₁₂ | 17 | Young's modulus (E) | 142 |
| c₄₄ | 46 | Shear modulus (μ) | 46 |

Mechanical properties of a superionic conductor are important in making flexible all-solid-state batteries. One can extract the elastic tensors of Li₃SBF₄ from the acoustic branches of its phonon spectrum in FIG. 3B (see the Methods section). Other elastic constants of the material can be further computed using the elastic tensors (see the Methods section). These values are given in Table II. There is a threshold for the shear modulus above which the dendric growth of a Li metal anode can be inhibited by a solid electrolyte. This threshold is four times the shear modulus of the Li metal, which is about 35 GPa. The shear modulus of Li₃SBF₄ is 46 GPa which is well above the threshold. Typical flexible materials often have both small Young's modulus and Poisson's ratio. The Young's modulus of Li₃SBF₄ is 142 GPa, between the values of copper (125 GPa) and mild steel (210 GPa). The Poisson's ratio of the material v=0.1 is between those of carbon fiber (0.045) and aluminum (0.34). All these results suggest that the superionic conductor Li₃SBF₄ has the desired mechanical properties for flexible electronics.

In summary, we report a new family of “super” lithium-rich antiperovskites (super-LRAP) composed of cluster ions and find that the lithium superionic conductors Li₃SBF₄ and Li₃S(BF₄)_{0.5}Cl_{0.5} have great potential for solid electrolytes. Li₃SBF₄ exhibits a band gap of 8.5 eV, a RT conductivity of 10⁻² S/cm, an activation energy of 0.210 eV, a relatively small formation energy and desired mechanical properties. Its mixed phase with halogen, Li₃S(BF₄)_{0.5}Cl_{0.5}, exhibits a RT conductivity over 10⁻¹ S/cm and an activation energy of 0.176 eV. The high melting point over 600 K and the very low activation energy allow these materials to operate over a wide range of temperatures, from below −3° C. with conductivity above 10⁻³ S/cm to over 30° C. with conductivity well above 10⁻¹ S/cm. The superior properties of the materials are achieved due to the following reasons: (1) Cluster ions, called super-halogens, having higher VDE than that of chlorine can produce larger band gaps of the super-LRAP than Li₃OCl. With proper ionic radius and proper internal charge distribution, a cluster ion can stabilize the antiperovskite structure with large channel size which provides more space for Li⁺ to migrate. A large channel size also produces a set of low-energy phonon modes called quasi rigid unit modes (q-RUMs) which correspond to the translational and rotational motions of the super-halogens acting more like rigid bodies. These motions generate a constantly shifting and varying potential surface throughout the material, which then facilitates the fast-ion migration of Li⁺ ions from one site to another. Partial replacement of the large super-halogen with halogen inside the antiperovskite structure creates large redundant space around the halogen sites. This enables an unusually large channel size of the material and further improves the ionic conductivity of a super-LRAP.

### The Methods Used to Obtain the Results Above are as Follows.

For the Cluster Calculations of VDE and IP:

The calculations are carried out using the GAUSSIAN 03 package. The hybrid density functional theory (DFT) with Becke three parameter Lee-Yang-Parr (B3LYP) prescription for the exchange-correlation energy and 6-31+G(d,p) basis sets are used. The optimized ground states correspond to the structures with the minimum energy and without any imaginary frequency.

For the Geometry Optimizations:

Density Functional Theory (DFT) calculations are carried out to optimize the unit cell of the super-LRAP using Perdew-Burke-Ernzerh (PBZ) generalized gradient approximation (GGA) for exchange-correlation functional (Pewdew, et al. Phys. Rev. Lett. 77, 3865 (1996)) implemented in the VASP package (Kresse, et al. J. Comput. Mater. Sci. 6, 15-50 (1996)). The projector augmented wave (PAW, Kresse, et al. Phys. Rev. B. 54, 11169-11186 (1996)) pseudopotential method and a 8×8×8 Monkhorst-Pack k-point mesh is employed in the calculation. The cutoff energy is 550 eV. The energy convergence is set to 10⁻⁶ eV and the force convergence is set to 0.005 eV/Å. The van der Waals interaction (as implemented in the DFT+D2 method (Grimme, J. Comput. Chem. 27, 1787 (2006)); Fang, et al. Phys. Rev. B 90, 054302 (2014)) is considered during the optimization calculations.

For the Internal Charge Distribution of the Clusters:

Bader charge analysis is used to obtain charge distribution of the clusters in the studied crystals.

For the Lattice Dynamics:

The phonon dispersion relations of the super-LRAP are calculated using the Density Functional Perturbation Theory (DFPT) with the van der Waals interaction. Geometry of the unit cell is optimized with an energy convergence of 10⁻⁸ eV and force convergence of 10⁻⁴ eV/Å. Phonon frequencies are first calculated on a q-grid of 5×5×5. Frequencies for other q points are then interpolated from the calculated points.

For the q-RUMs of the Super-LRAP:

The q-RUMs of the studied materials are found by mapping the phonon eigenvectors of a model system containing rigid super-halogen ions to the eigen vectors of the studied system. The model system is created and calculated using an improved version of CRUSH code (Giddy, et al. Acta Crystallographica A 49, 697-703 (1993); Hammonds, et al. American Mineralogist 79, 1207-1209 (1994)).

For the Potential Terms Created by BF₄⁻:

The interaction potential created by each of the BF₄⁻ units on the Li⁺ ion can be expressed by a multipole expansion

$$φ ( \vec{r} ) = \frac{1}{4 π {ɛ}_{0}} [ \frac{q}{r} + \frac{\vec{p} \cdot \vec{r}}{{r}^{3}} + \frac{1}{2} {\sum }_{ij} \frac{{r}_{i} {r}_{j}}{{r}^{5}} {Q}_{ij} + … ] , \qquad ( m 1 )$$

where q=−e is the total charge of the BF₄⁻ super-halogen ion and \vec{r} the vector from boron at the center of one BF₄⁻ unit to the Li⁺ ion. \vec{p} is the dipole moment generated by the charge distribution inside one BF₄⁻ unit,

$$\vec{p} = {\sum }_{i = 1}^{4} {q}_{i}^{F} {\vec{R}}_{i}^{F} - q \vec{r} = {\sum }_{i = 1}^{4} {q}_{i}^{F} {\vec{r}}_{i}^{F} , \qquad ( m2 )$$

where qᵢ^{F}=−0.25e is the charge on each F atom in the model (FIG. 4A), \vec{R}ᵢ represent the coordinates of each F atom and \vec{r}ᵢ is the relative coordinate of each F atom from the boron center. Qᵢⱼ is the quadrupole term,

$${Q}_{ij} = {\sum }_{k = 1}^{4} {q}_{k} ( 3 {R}_{i}^{k} {R}_{j}^{k} - {R}^{2} {δ}_{ij} ) , \qquad ( m 3 )$$

where qₖ is the charge on each F atom and Rᵢ^{k} is the i^{th} coordinate of the k^{th} F atom. In Eq. (m1), both the dipole and the quadrupole terms are determined by the orientational symmetry of the BF₄⁻ unit inside the cubic cell.

For the Thermodynamics and Superionic Conductivity:

Ab initio molecular dynamics (AIMD) simulations are conducted using a 3×3×3 supercell and 1.0 fs time step in an NpT ensemble to study the thermodynamics of the material at 400 and 600 K. To study the Li⁺ transport, AIMD simulations with 2.0 ps time step and NVT ensemble are carried out at 550, 650, 750, 900 and 1000 K using a 2×2×2 supercell with one Li⁺ vacancy to speed up the ion hopping process. At each temperature, the AIMD lasts over 130 ps after a 40 ps pre-equilibrium run to make the linear fitting to the averaged mean square displacement (MSD) of Li⁺ converge. The diffusion coefficient (D) at each temperature is calculated by fitting to the MSD according to

$$D = {lim}_{t \to ∞} [ \frac{1}{6 t} 〈 {[ \vec{r} ( t ) ]}^{2} 〉 ] \qquad ( m4 )$$

with \vec{r}(t) the displacement of Li⁺ at time t. The conductivity (σ) is then calculated from the Nernst-Einstein relation

$$σ = D \frac{{Ne}^{2}}{kT} \qquad ( m5 )$$

with N being the number of ion pairs per cm³. Other symbols have their customary meaning. The activation energy Eₐ is obtained by using the Arrhenius model

$$σ = \frac{A}{T} exp ( \frac{{E}_{a}}{kT} ) , \qquad ( m6 )$$

where A is the fitting parameter.

For the Elastic Constants:

Instead of using the strain-stress method and the equation of state to calculate the elastic tensors and the modulus, we take advantage of the cubic symmetry of Li₃SBF₄ and calculate the elastic tensors of the material by using the following relations. The subscripts of ω denote the directions of motion of the atoms.

| k = [ξ, 0, 0] | k = [ξ, ξ, 0] | k = [ξ, ξ, ξ] |
|---|---|---|
| ρω²_{[100]} = c₁₁ξ² | ρω²_{[100]} = | ρω²_{[111]} = |
| | (c₁₁ + c₁₂ + 2c₄₄)ξ² | (c₁₁ + 2c₁₂ + 4c₄₄)ξ² |
| ρω²_{[010]} = c₄₄ξ² | ρω²_{[110]} = | ρω²_{[110]} = |
| | (c₁₁ − c₁₂)ξ² | (c₁₁ − c₁₂ + c₄₄)ξ² |
| ρω²_{[001]} = c₄₄ξ² | ρω²_{[001]} = 2c₄₄ξ² | ρω²_{[112]} = (c₁₁ − c₁₂ + c₄₄)ξ² |

The Young's modulus (E), shear modulus (u) and the Poisson's ratio (v) are then calculated as

$$\begin{matrix}E = \frac{{c}_{11}^{2} + {c}_{12} {c}_{11} - 2 {c}_{12}^{2}}{{c}_{11} + {c}_{12}} & ( m7 ) \\ μ = {c}_{44} & ( m8 ) \\ υ = \frac{{c}_{12}}{{c}_{11} + {c}_{12}} . & ( m9 )\end{matrix}$$

Properties of Li₃O(BH₄)

### Mechanical

Lightweight batteries with excellent flexibility are necessary to power wearable electronics and implantable medical devices. Given the weight of Li₃O(BH₄) being only about half of those of Li₃OA (A=halogen), we find that this exemplary material also shows favorable mechanical properties. From the phonon spectrum, we extracted the elastic tensors of Li₃O(BH₄) from the acoustic branches at the three wave vectors [x, 0, 0], [x, x, 0] and [x, x, x]. Other elastic constants are further calculated from the elastic tensors as tabulated in Table III. For the lithium solid electrolyte, there is a threshold for the shear modulus above which the dendritic growth of the Li anode can be inhibited. For materials with a small Poisson's ratio (close to zero), the threshold is four times the shear modulus of Li metal, which is about 35 GPa. The shear modulus of Li₃O(BH₄) (51 GPa) is well above this threshold. Compared to typical ductile materials with both small Young's modulus and Poisson's ratio, Li₃O(BH₄) shows a Young's modulus (114 GPa) between those of copper (125 GPa) and aluminum (75 GPa). Its Poisson's ratio (0.1) is between those of aluminum (0.34) and the carbon fiber (0.045). These indicate that the Li₃O(BH₄) conductor has good flexibility.

TABLE III
Calculated elastic constants of Li₃O(BH₄). According to the
cubic symmetry, there are only three distinctive elastic tensors c₁₁,
c₁₂ and c₄₄. E is the Young's modulus, n the Poisson's
ratio and m the shear modulus. All in the unit of GPa.

| | | | |
|---|---|---|---|
| c₁₁ | 116 | E | 114 |
| c₁₂ | 12 | ν | 0.1 |
| c₄₄ | 51 | μ | 51 |

### Compositional Mixing of BH₄ and Cl

One way to improve superionic conductivity is to prepare a material that is chemically and structurally more disordered. We find that the mixed phase of Li₃O(BH₄)_{0.5}Cl_{0.5} with a lithium vacancy shows a significantly enhanced Li⁺-ion conductivity. Calculation of the diffusion coefficients at different temperatures gave a room-temperature conductivity of 0.21×10⁻³ S cm⁻¹. This value is identical to that of Li₃OCl_{0.5}Br_{0.5}. It is noted that although such a method can reproduce the correct relative ratio, i.e. 2:1 of Li₃OCl_{0.5}Br_{0.5} vs. Li₃OCl and Li₃O(BH₄)_{0.5}Cl_{0.5} vs. Li₃O(BH₄), the absolute value is likely underestimated. Given the same theoretical conductivity of Li₃OCl_{0.5}Br_{0.5} and Li₃O(BH₄)_{0.5}Cl_{0.5}, it is expected that Li₃OCl_{0.5}Br_{0.5} can reach a similar Li⁺ conductivity of over 10⁻³ S cm⁻¹. The activation energy of Li₃O(BH₄)_{0.5}Cl_{0.5} is 0.299 eV which is also similar to 0.288 eV of Li₃OCl_{0.5}Br_{0.5}. Given low activation energies of Li₃O(BH₄) and Li₃O(BH₄)_{0.5}Cl_{0.5}, their Li⁺ conductivity at a high temperature of 400 K would reach 1.3×10⁻² S cm⁻¹ and 2.6×10⁻² S cm⁻¹, respectively.

### Suggested Route to Experimental Synthesis

Li₃O(BH₄) is synthesized in a similar manner to that of Li₃OA crystals, namely by replacing halogens with BH₄ superhalogens. We note that the reaction of Li₂O+LiA gives rise to Li₃OA. To calculate the feasibility of synthesizing Li₃O(BH₄), the energetics of the reactions Li₂O+LiA/Li₃OA and Li₂O+LiBH₄/Li₃O(BH₄) were calculated. Both reactions are endothermic; while the formation of Li₃OA requires 13.9 and 25.8 meV per atom for A=Cl and Br, respectively, Li₃O(BH₄) would require 58.8 meV per atom. We further find that the molar volume of Li₃O(BH₄) is about 17% more compact than the combined molar volumes of Li₂O and LiBH₄. However, if we start with Li₂O and LiBH₄ as clusters, the formation of the Li₃O(BH₄) cluster instead of the crystal becomes exothermic with about 200 meV per atom. Thus, it is easier to synthesize Li₃O(BH₄) from Li₂O and LiBH₄ e.g. under high pressures. Also, using Li₂O₂ instead of Li₂O introduces lithium deficiencies in the synthesized Li₃O(BH₄), thus improving its superionic conductivity.

Thus, by using BH₄⁻, new physical and chemical degrees of freedom have been introduced into the superionic conductor family of Li₃OA (A=halogen).

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A solid superionic conductor material comprising
i) Li or Na super-alkali cluster cations;
ii) super-halogen cluster anions; and, optionally,
iii) halogen anions,
wherein the superionic conductor material has an antiperovskite crystal structure.

2. The solid superionic conductor material of claim 1, wherein the Li or Na super-alkali cluster cations are selected from the group consisting of: Li₃O⁺, Li₃S⁺, Na₃O⁺ and Na₃S⁺.

3. The solid superionic conductor material of claim 1, wherein the super-halogen cluster anions are selected from the group consisting of: BH₄⁻, AlH₄⁻, BF₄⁻ and BCl₄⁻.

4. The solid superionic conductor material of claim 1, wherein the halogen anions are selected from the group consisting of: Cl⁻, Br⁻ and I⁻.

5. The solid superionic conductor material of claim 1, wherein ionization potentials of the Li or Na super-alkali cluster cations are smaller than those of alkali elements.

6. The solid superionic conductor material of claim 1, wherein vertical detachment energies of the super-halogen cluster anions are larger than those of halogen elements.

7. The solid superionic conductor material of claim 1, comprising Li₃SBF₄.

8. The solid superionic conductor material of claim 1, comprising Li₃S(BF₄)₁₋ₓClₓ, where 0<x<1.

9. The solid superionic conductor material of claim 1, wherein a band gap is at least about 4.0 eV.

10. The solid superionic conductor material of claim 9, wherein the band gap is about 8.5 eV.

11. The solid superionic conductor material of claim 1, wherein an activation energy is 0.25 eV or less.

12. The solid superionic conductor material of claim 10, wherein the activation energy is about 0.210 eV.

13. The solid superionic conductor material of claim 10, wherein the activation energy is about 0.176 eV.

14. The solid superionic conductor material of claim 1, wherein the RT Li⁺ ionic conductivity is 10⁻³ S/cm or greater at room temperature (RT).

15. The solid superionic conductor material of claim 12, wherein the three-dimensional RT Li⁺ ionic conductivity is above 10⁻² S/cm.

16. The solid superionic conductor material of claim 12, wherein the three-dimensional RT Li⁺ ionic conductivity is above 10⁻¹ S/cm.

17. The solid superionic conductor material of claim 1, wherein a melting point is 400 K or greater.

18. A rechargeable solid-state battery comprising
i) an anode
ii) a cathode; and
iii) a solid superionic conductor material comprising
Li or Na super-alkali cluster cations;
super-halogen cluster anions; and, optionally,
halogen anions,
wherein the superionic conductor material has an antiperovskite crystal structure.

19. The rechargeable solid-state battery of claim 18, wherein the solid superionic conductor material is Li₃SBF₄ or Li₃S(BF₄)₁₋ₓAₓ where A is Cl, Br or I and 0<x<1.

20. The rechargeable solid-state battery of claim 18, wherein the solid superionic conductor material is Na₃SBCl₄ or Na₃S(BCl₄)₁₋ₓAₓ where A is Cl, Br or I and 0<x<1.

21. A rechargeable device or vehicle comprising the rechargeable solid state battery of claim 18.
